(19) United States
(12) Patent Application Publication
(10) Pub. No.: US 2006/0201439 A1
(43) Pub. Date: Sep. 14, 2006

(54) Animal tote with compartmented divider system

(76) Inventors: Paul Ficker, Milford, OH (US); Richard S. Phelan, Germantown, NY (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/365,495

(22) Filed: Mar. 2, 2006

Related U.S. Application Data
(60) Provisional application No. 60/659,403, filed on Mar. 9, 2005.

(51) Int. Cl. A01K 1/00

(52) U.S. Cl. 119/416

(57) ABSTRACT

An animal tote includes a container having a bottom wall and opposed side and end walls connected together to form an interior cavity having an open top covered by a lid. A plurality of spaced openings constituting air holes is formed in the walls and a divider system is positioned in the cavity to form a plurality of separate inner compartments, with each compartment being closed by a separate cover. The container lid is positioned over the individual covers when the compartment is closed.

### BACKGROUND OF THE INVENTION

1. Field of the Invention

This invention relates to a tote or container for holding and transporting animals and, more particularly, to an animal tote having individually covered compartments for individually holding and transporting small laboratory animals such as rats, mice and other rodents.

2. Description of the Related Art

Totes or container of various types and sizes are known in the art for use in connection with shipping small animals such as rodents used for medical and experimental purposes. One example of such an animal tote is disclosed in U.S. Pat. No. 5,572,953 which discloses a unitary injection molded plastic container having a bottom wall, opposed side walls and opposed end walls with an open top covered by a lid. Air flow passages are formed in the lid and in one or more of the side and end walls, which may be covered with an air filter material. The interior of the container also may include dividers for dividing the interior into separate compartments.

Another container for transporting laboratory animals is disclosed in U.S. Pat. No. 6,588,373. This container has an open top covered by a lid having a passage through which at least one laboratory animal may pass during insertion into and extraction from the interior of the container. The side walls and the top include a plurality of air holes which are covered by a filter material held in place by a filter guard mechanically attached to the container.

Another example of a container for shipping small animals is disclosed in U.S. Pat. No. 6,543,387. This patent discloses a container having an open top box divided into compartments by interior partitions. Air holes are provided in the lid and walls which are covered by a filter cloth. The lid includes two separate pivotal covers for the compartments inside of the container.

While the prior art containers are acceptable, there still is a need for an animal tote or container having a plurality of compartments inside, which are each provided with a separate cover for opening and closing the compartment. Moreover, there continues to be a need for such compartmented containers which also are provided with air holes protected by a filter material.

### SUMMARY OF THE INVENTION

It is an object of the present invention to provide a stackable, molded plastic animal tote or container that has an interior divider system for forming a plurality of interior compartments, each of which has its own separate cover for opening and closing the compartment. The separate covers are in addition to the lid of the animal tote or container which covers the entire open top of the container.

It is a further object of the present invention to provide a container having multiple interior covered compartments with air holes or passages leading into the container through walls thereof that are covered with a filter material secured in place by a removable grid so that the filter material may be easily installed and removed or replaced. Alternatively, the filter material may be sonic welded to the container where both the filter material and the container are constructed of a thermoplastic material.

The present invention achieves the above and other objects by providing an animal tote comprising a container having a bottom wall, opposed side walls and opposed end walls connected together to form an interior cavity having an open top. A plurality of spaced openings constituting air holes are formed in at least one of the side walls and end walls. A divider system is mounted in the cavity to form a plurality of separate interior compartments. A plurality of spaced openings are formed in at least certain of the dividers to provide air holes for each of the compartments. The air holes may be covered with a filter material. A separate openable cover is provided for each of the compartments. A lid is provided for covering the open top of the container and which is positioned over the individual covers for the compartments.

### BRIEF DESCRIPTION OF THE DRAWINGS

FIG. 1 is a side elevational view of the animal tote of the present invention;

FIG. 2 is a top view of the animal tote of FIG. 1 showing the lid of the animal tote with the filters and filter frames removed;

FIG. 3 is a side view of the animal tote of FIG. 1 with the filter and filter frame removed;

FIG. 4 is a prospective view showing the container body of the tote and a system of dividers in a disassembled state;

FIG. 5 is top plan view of the body of the container showing a system of dividers mounted therein with two of the compartments formed by the dividers being covered by separate covers;

FIG. 6 is a prospective view of a system of dividers of the animal tote of the present invention;

FIG. 7 is a front elevational view of a widthwise wall of the system of dividers shown in FIG. 6;

FIG. 8 is a front elevational view of a lengthwise wall of the system of dividers shown in FIG. 6; and

FIG. 9 is a top view of the animal tote of FIG. 1 showing the lid with filters and filter frames in place.

### DETAILED DESCRIPTION OF THE PREFERRED EMBODIMENTS

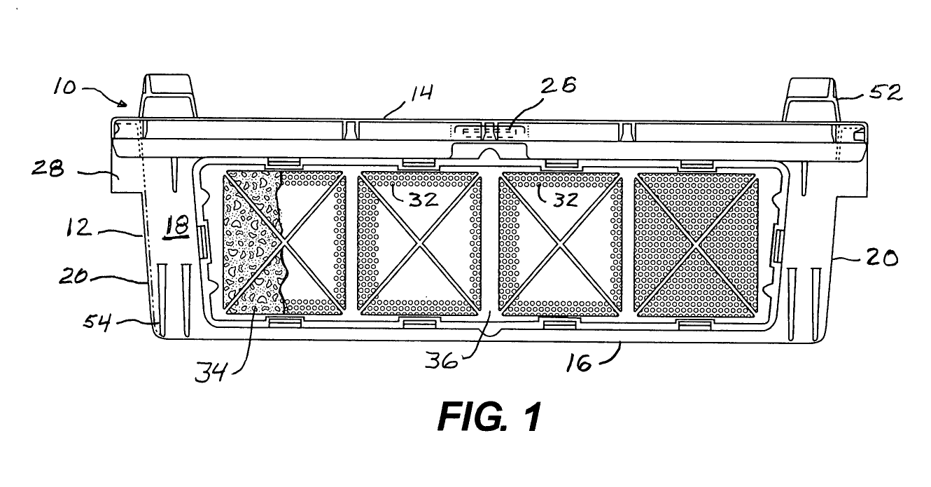

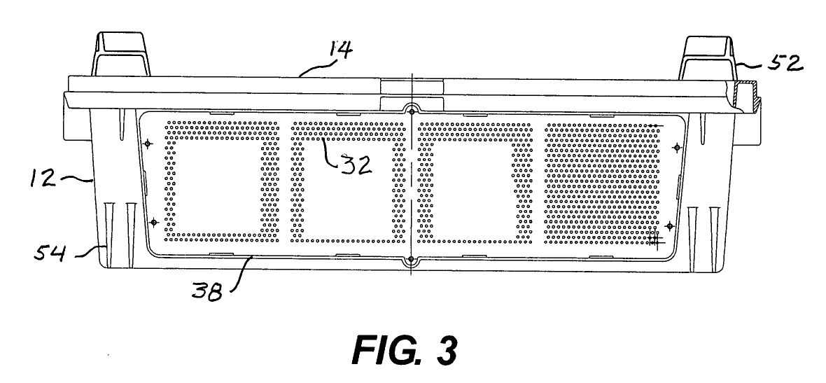

Illustrated in FIGS. 1-9 is an animal tote 10 according to the present invention. The animal tote 10 includes a container 12 having a lid 14 to cover the top thereof. Each tote preferably is molded separately of a rigid, high thermosetting plastic such as polypropylene having high flow characteristics and high heat stability characteristics. The container is of the same type as that illustrated and described in U.S. Pat. No. 5,572,953, which is incorporated herein by reference.

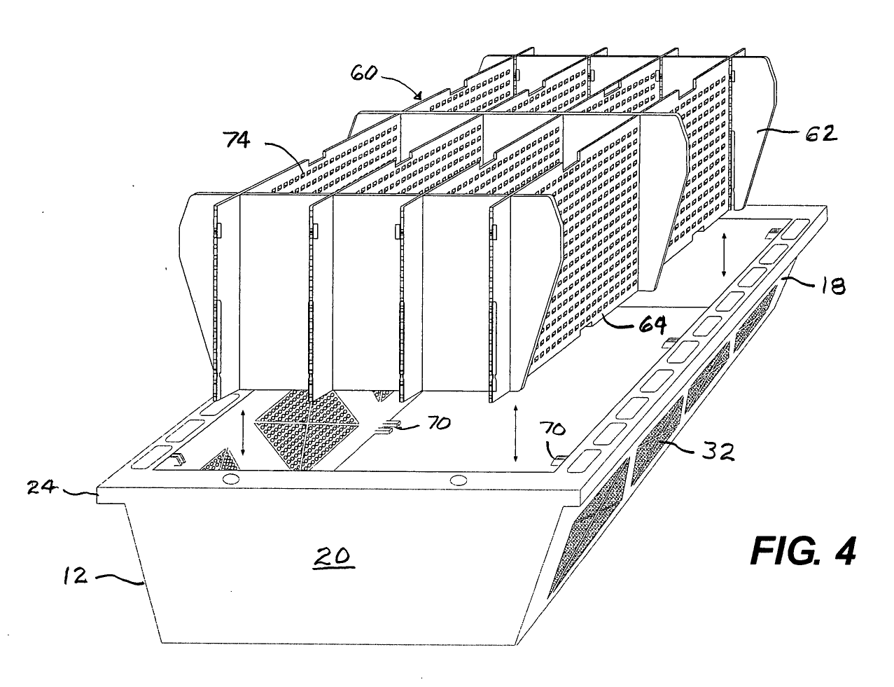

Each container 12 is constructed having a bottom wall 16, a pair of opposed side walls 18 and a pair of opposed end walls 20 connected together to form an interior cavity 22 having an open top. The container 12 has an outer lip or rim 24 extending around the edges of the top as shown in FIG. 4. The lid 14 is provided with a plurality of snap fitting flanges 26 which snap over the edge 24 to lock the lid in place over the container as shown in FIG. 1.

The side and end walls are sloped inwardly toward the bottom wall 16 from the open top of the container to permit nesting of similar containers when the lids are not in place. Flanges 28 located around the periphery of the container function as nesting stops when a plurality of containers is nested together in a vertical stack. Moreover, side walls 18 are slopped inwardly to a greater extent then required for nesting to provide, in combination with flanges 28, sufficient separation distance between adjacent totes when the totes are placed side by side either individually or in stacks. Accordingly, side by side separation is maintained to ensure adequate ventilation between adjacent containers.

To further provide adequate ventilation in the container, the side walls 18 of the container are provided with arrays of minute holes 32 through which air may pass into the interior of the container as shown in FIG. 1. Although not shown in the drawings, one or both of the end walls 20 also may be provided with holes. To prevent contaminated air from entering the interior of the container through the holes 32, the holes are covered with a filter material 34 that is held in contact with the holes by container filter frames 36, constructed of a suitable plastic material such as polypropylene, as also shown in FIG. 1. The filters may be constructed of a spun polypropylene blend material and may also contain an antiseptic type material to kill germs on contact. The filter may be a self-adhesive type filter. The filter 34 and frame 36 fit in a recess 38 formed in each side wall of the container with the recess also containing the arrays of holes 32. If a self adhesive type filter is used, the frame may be omitted. Moreover, where both the container and the filter are constructed of a thermoplastic material, the filter may be sonic welded to the container and a frame to hold the filter is not required.

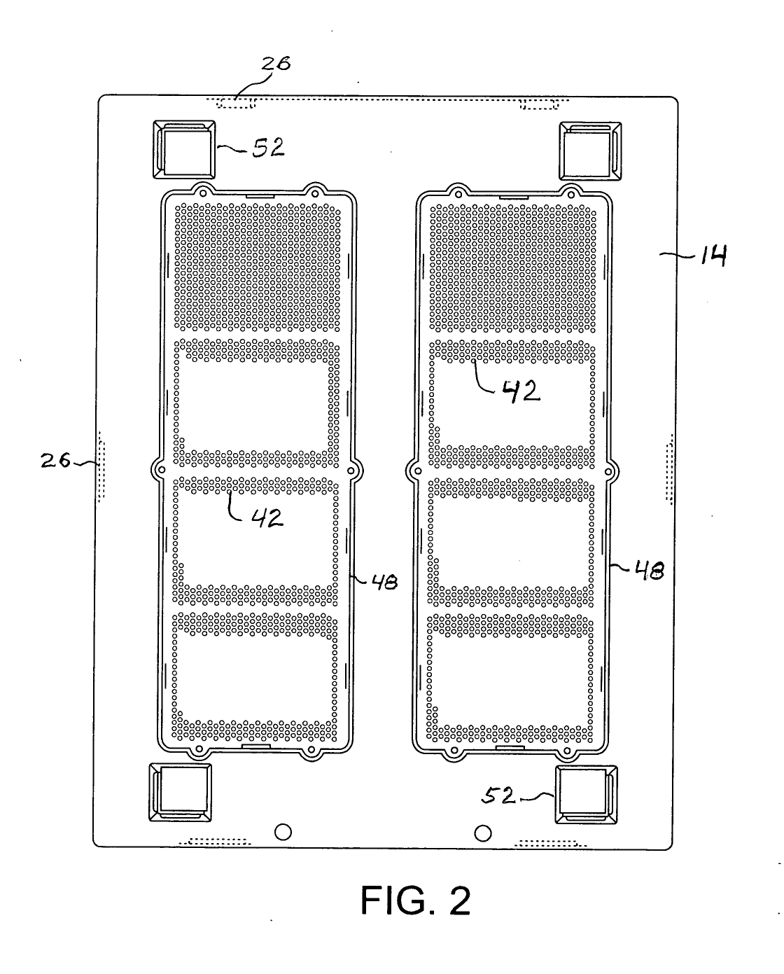

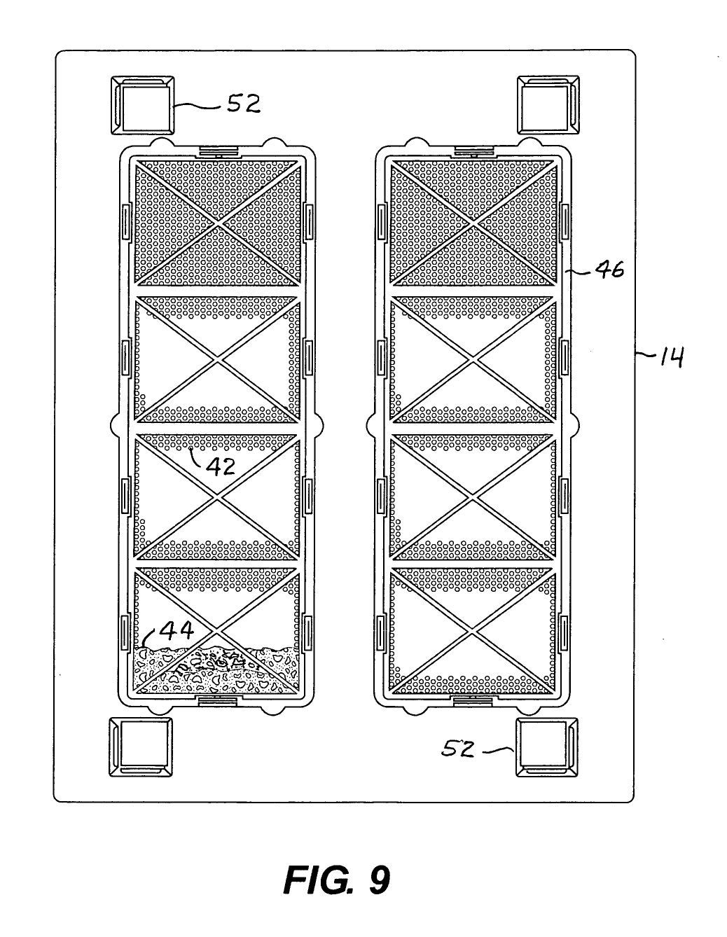

In addition, as shown in FIGS. 2 and 9, the lid is provided with a plurality of arrays of air holes 42 in recesses 48 formed in the lid. Air holes 42 also are covered with a filter material 44 and the filter material is held in place by a filter frame 46 also positioned in the recess 48 and mechanically connected to the lid.

The upper surface of the lid 14 is provided with upwardly extending stacking posts 52 adjacent the corners which are adapted to mate with outside corner flanges 54 of another identical container when two containers are stacked together. Since the stacking posts 52 extend above the surface of the lid and mate with the bottom portion of the corner flanges 54, when the totes are stacked in a vertical stack with the lids on, a separation distance is maintained between the top of one lid and the bottom wall of an adjacent stacked container. The maintaining of this vertical separation distance between two stacked totes further facilitates the passage of air into and out of the container.

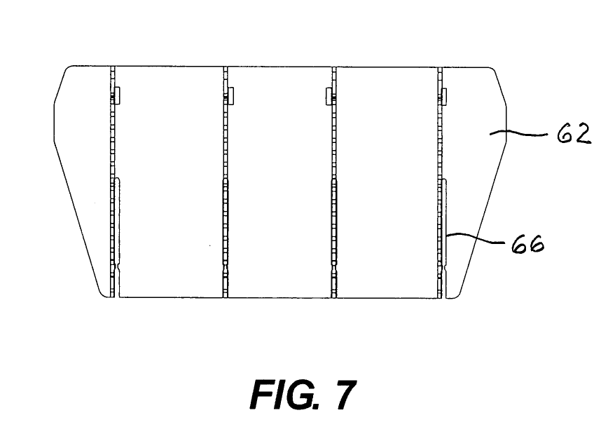

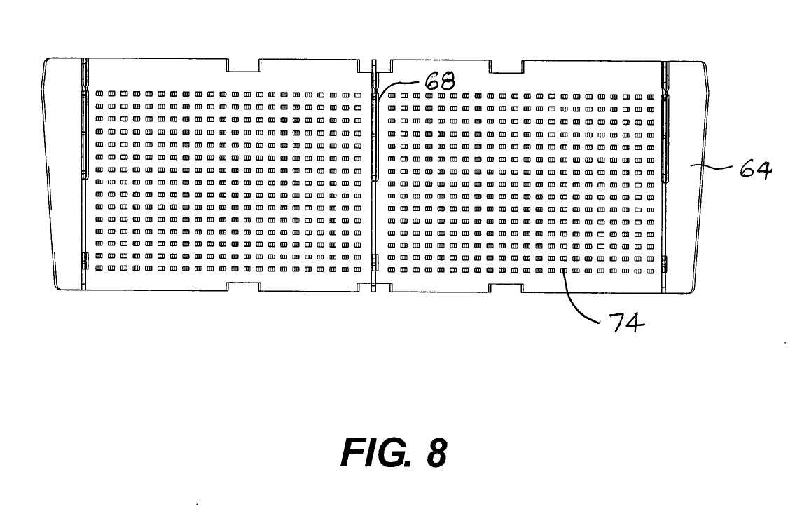

As shown in FIGS. 4-8, a system of dividers, generally indicated by the numeral 60, is adapted to fit snugly into the interior cavity 22 of each container 12. The system of dividers is comprised of a plurality of spaced widthwise walls 62 positioned in interlocking relationship with a plurality of spaced lengthwise walls 64. The widthwise walls 62 are provided with vertical slots 66 and the lengthwise walls 64 are provided with vertical slots 68 as shown in FIGS. 7 and 8, respectively, whereby when the walls are formed into a system of dividers, the two sets of slots are connected in an interlocking relation as shown in FIG. 4.

The outer ends of the widthwise walls 62 and the lengthwise walls 64 are slanted inwardly from the top to the bottom to conform to the slanting configuration of the side and end walls of the container 12. In addition, as shown in FIG. 4, the container 12 may be provided with slots 70 spaced around the outer edges and on the inner portion of the bottom wall 22 to securely retain the system of dividers in the interior cavity of the container.

Either or both of the walls 62 and 64 may be provided with arrays of air holes 74 to permit ventilation between individual compartments 76.

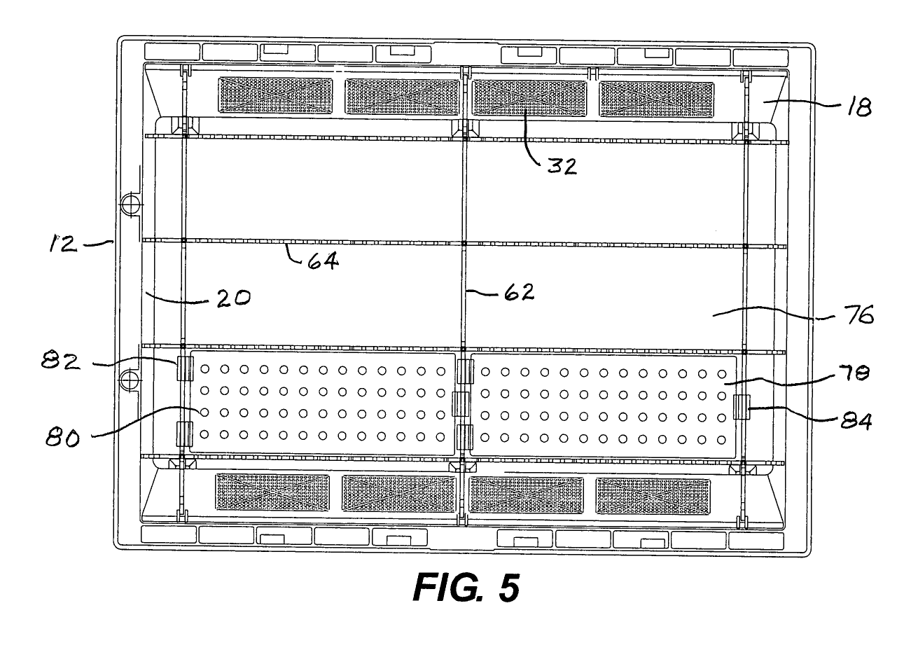

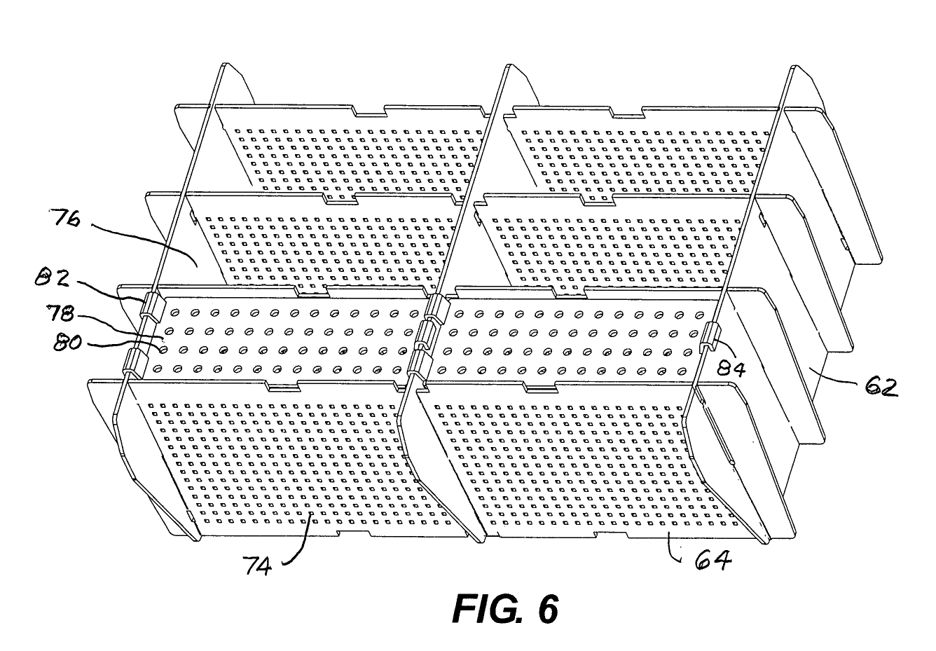

Each of the compartments 76 is provided with a cover 78 having a plurality of air holes 80 formed therein. While only two covers 78 are shown in FIGS. 5 and 6, in the preferred embodiment, each of the individual compartments 76 is provided with a perforated cover 78. The covers over the compartments may be held in place in a number of suitable ways. Thus, as shown in FIGS. 5 and 6, each cover 78 is connected by hinges 82 at one end and a snap connector 84 at an opposite end to connect to widthwise walls 62. Alternatively, both ends of each cover may be connected by snaps 84 or other latch means.

A significant advantage of forming a plurality of individually covered compartments in the container portion of each animal tote is that individual animals can be kept in individual compartments and the animals may be loaded or unloaded from the compartments one at a time without the remaining animals being freed. This is particularly advantageous when laboratory animals are involved since it is often desirable to have each of the animals separated from each other.

In another embodiment, the lid 14 of the animal tote may be utilized to hold the dividers covers in place by being placed right above the covers.

While preferred embodiments have been set forth with specific details, further embodiments, modifications and variations are contemplated according to the broader aspects of the present invention.

1. An animal tote comprising:
a container having a bottom wall, opposed side walls and opposed end walls connected together to form an interior cavity having an open top;
a plurality of spaced openings constituting air holes formed in at least one of said side walls and end walls;
dividers mounted in said cavity to form a plurality of separate compartments therein;
a plurality of spaced openings formed in at least certain of said dividers to provide air holes for each of said compartments;
a separate openable cover for each of said compartments for individually opening and closing each of said compartments; and
a lid for covering said open top of said container.

2. An animal tote according to claim 1, wherein said dividers comprise intersecting widthwise and lengthwise walls which form said compartments.

3. An animal tote according to claim 2 which further comprises slots formed on the interior of said cavity which receive at least some of said walls therein.

4. An animal tote according to claim 2, wherein said spaced openings in at least certain of said dividers are formed only in said lengthwise walls of said compartments.

5. An animal tote according to claim 1, wherein each of said covers is provided with a plurality of spaced openings constituting air holes therein.

6. An animal tote according to claim 1, wherein each of said covers is hingedly connected to one of said compartment walls.

7. An animal tote according to claim 1 further comprising a filter covering said plurality of spaced openings formed in at least one of said sidewalls and end walls.

8. An animal tote according to claim 7 further comprising a frame for holding said filter.

9. An animal tote according to claim 7 wherein said container and said filter are constructed of the thermoplastic material and said filter is attached to said container by sonic welding.

10. An animal tote according to claim 1 wherein said plurality of spaced openings are formed in each of said side walls and a filter covers said spaced openings in each of said side walls.

11. An animal tote according to claim 10 wherein said lid is provided with a plurality of spaced openings and a filter covers the spaced openings in said lid.
